(19) United States
(12) Patent Application Publication
(10) Pub. No.: US 2026/0324703 A1
(43) Pub. Date: Oct. 22, 2026

(54) DEVICE AND METHOD FOR TREATING ANIMAL FODDER

(71) Applicant: FARM & STABLE GMBH & CO. KG, Wiehl (DE)

(72) Inventor: Lionel Kilbey, Wiehl (DE)

(73) Assignee: FARM & STABLE GMBH & CO. KG, Wiehl (DE)

(21) Appl. No.: 18/881,068

(22) PCT Filed: Jul. 4, 2023
(86) PCT No.: PCT/EP2023/068464

§ 371 Date: Jan. 3, 2025

(30) Foreign Application Priority Data
Jul. 5, 2022 (GB) 2209886.7
Jan. 19, 2023 (GB) 2300781.8

(51) Int. Cl. A23N 17/00; A23K 10/30; A23K 30/10; A23K 50/20

(52) U.S. Cl. CPC A23N 17/004; A23K 10/30; A23K 30/10; A23K 50/20

(57) ABSTRACT

The invention provides an apparatus and process for the steam treatment of animal fodder (or other plant fibres). The arrangement of steam distributors within the apparatus provides for more rapid and efficient treatment of the fodder.

The present invention relates to a device and a method for use in treating plant fibres with steam and/or moisture, for example animal fodder (such as hay, grasses, herbaceous legumes, tree legumes, silage and crop residues) or industrial fibres (such as industrial hemp fibre).

### BACKGROUND OF THE INVENTION

Livestock widely consume fodder. Fodder includes hay, straw, silage, compressed and pelleted feeds, oils and mixed rations, and sprouted grains and legumes (such as bean sprouts, fresh malt, or spent malt). The quality and nutrition of fodder can vary widely depending on the moisture content and the microbial population present.

Grass hay is a common fodder type fed to stabled horses. The nutrient content of both hay is mainly determined by the grass mixture and stage of growth at harvest, while the hygienic quality is influenced by weather during the conservation process and storage conditions. Hay or haylage (40-60% moisture content hay that is preserved by fermentation) can also supply a significant proportion of the daily nutrient requirements.

Conserved hay can contain significant levels of respirable dust. Respirable dust is composed of particles less than 5 μm in size and comprises particles that are sufficiently small (0.5-5 μm) to penetrate the peripheral airways. Respirable dust contains potentially allergenic particles which have the potential to contribute to equine environmental airway diseases including Recurrent Airway Obstruction (RAO) in stabled horses. Maintaining an RAO horse in an asymptomatic condition is best done by reducing the dust/animal interaction. During feeding, dust in the breathing zone of the horse can be significantly higher than in the general stable environment thus minimising dust released from feed is paramount. To reduce the dust released from hay fodder many owners soak or steam their hay before feeding. Respirable dust can also provoke or exacerbate chronic obstructive pulmonary disease (COPD) in humans.

It has been found that soaking has more negatives than positives; it increases bacterial incubation in the fodder because of the moisture level, and is also known to cause nutrient loss. It has also been found that soaking reduces the level of nutrients including minerals, protein and nonstructural carbohydrates (NSC) in the fodder. For these reasons, steaming of fodder, particularly once baled, is generally preferred as it kills the majority of the microorganisms such as bacteria, mould, yeast, dust mites, and the like. Additionally, steaming generally conserves nutrients, and loss of phosphorus and nonstructural carbohydrates (NSC) is comparatively less.

Various methods and apparatuses are known from the prior art which focus on steam treatment of fodder; however, they suffer from drawbacks in terms of efficiency, inadequate moisture delivery, irregular temperature and pressure distribution and insufficient penetration in the bales of fodder. Devices of the prior art fail to concentrate or control steam at the particular area where it is most needed, thereby resulting in uneven treatment of plant fibres.

### BRIEF DESCRIPTION OF PRIOR ART

EP2364100 describes an apparatus for steam treating fodder which includes a steam manifold that is adapted to receive steam from a source, the manifold defining passages for distributing steam to a plurality of lances, said lances being adapted so that in use, they penetrate a bale of fodder, whereby steam is supplied to the interior volume of the fodder.

DE102015015372A1 describes another kind of hay steamer consisting of a box with hinged lid and an external source of water vapor.

WO2021044164A1 discloses an apparatus for steam treating plant fibres wherein steam is delivered by lances into the interior volume of the plant fibres; the weight of the bale assists in the process of ensuring the lances penetrate the bulk of the bale. The steam is mainly concentrated on the inner side of the bale of plant fibres.

GB2338167A describes an apparatus for the control of control of spores related to straw or hay-based material. This comprises an enclosure adapted to receive and support straw or hay-based material; a supply pipe located in the enclosure, the supply pipe being equipped with apertures along its length; and steam generating means coupled to the supply pipe to enable a supply of steam or hot water to be injected through the apertures and so into straw or hay-based material located in the enclosure.

GB2374513A discloses a device for preparing a horse's food comprising a vessel having a lid which can be opened to enable hay to be placed in and removed from the vessel. A steam generator is connected to the vessel so that steam passes into the vessel and hay contained within the vessel on top of a mesh grid is subject to the action of the steam. After the hay has been treated with steam, it is removed from the vessel and given to the horse.

GB2387311 describes a steamer capable of holding hay and feed of any required quantity having an outer container fitted with an electric heating element. The base of the outer container acts as a water reservoir. An inner basket is supported above the maximum water level. The inner basket holds the hay or feed for steaming. A lid is placed on top of the outer container. A boiling chamber is fitted around the heating element to restrict the water volume and assist boiling. The steam produced escapes from the top of the boiling chamber through holes, a cover plate attached to the boiling chamber prevents feed falling onto the chamber and helps disperse the steam.

U.S. Pat. No. 4,604,857 relates to a hay pre-conditioner mounted on a hay-baler so as to be disposed in front thereof and raisable thereto, wherein the hay pre-conditioner is comprised of an elongated, box-like structure having a plurality of transversely mounted steam outlet nozzles for conditioning a windrow of hay in front of the baler.

A problem that persists in the field is the provision of a process and apparatus capable of steam treating hay (or other plant fibres) more rapidly, completely and evenly.

### SUMMARY OF THE INVENTION

According to a first embodiment, the invention provides an apparatus for steam treating animal fodder comprising:
i. a closable container having a floor, wall or walls abutting the floor, and a lid, together defining an interior volume for receiving a mass of animal fodder;
ii. a first steam distributor within the container adapted to receive steam from a source, comprising a first plurality of steam outlets;
iii. a second steam distributor within the container adapted to receive steam from a source, comprising a second plurality of steam outlets; wherein, in use, the mass of animal fodder is located substantially between the first and second steam distributors such that steam permeates into the mass of animal fodder from substantially opposite directions.

According to a second embodiment, the invention provides a method of steaming a mass of animal fodder comprising
i. placing the mass of animal fodder between a first and second steam distributor;
ii. delivering steam from a steam source through the first and second steam distributors;
iii. stopping the supply of steam when a predetermined volume of steam has been delivered.

### BRIEF DESCRIPTION OF THE DRAWINGS

FIG. 1 is a sectional view of a device according to one embodiment of the invention.

FIG. 2 is a sectional view of a device according to one embodiment of the invention.

FIG. 3 is an exploded view of a device according to one embodiment of the invention.

FIG. 4 is a projection view of a device according to one embodiment of the invention.

FIG. 5 is a projection view of the lower inner face a lid assembly according to one embodiment of the invention, showing the lid steam rail assembly.

FIG. 6 is a projection view of the top face a lid assembly according to one embodiment of the invention, showing the lid steam rail assembly.

FIG. 7 is a projection view of the inside of the chest molding of a device according to one embodiment of the invention.

FIG. 8 is a projection view of manifold and spigot (steam pipe) arrangement according to one embodiment of the invention.

### DETAILED DESCRIPTION OF THE PREFERRED EMBODIMENTS

The invention provides a device for treating animal fodder with steam and/or moisture and a method thereof. The invention further provides a device for treating animal fodder (or other plant fibres), wherein the heat is evenly distributed throughout the animal fodder placed inside the device.

In some embodiments, the steam introduced into the mass of animal fodder can be controlled. This is possible because of the controllable steam distributors between which the mass of animal fodder is placed. So far, there is no device or method known to the inventors which focuses on controlling the steaming at a particular region of a mass of animal fodder where the steam is concentrated or to bring a particular area of fodder up to a required temperature and/or moisture level.

The device comprises a closable container, which may be of any suitable shape. For example, it may be substantially cylindrical having a circular floor, a single curved wall abutting and perpendicular to the floor, and a cylindrical lid. This configuration is appropriate when a cylindrical bale of fodder is employed. Typically, these will have a length of 1.2 m and a diameter of 1.2 m.

It is preferred that the container is cuboidal or substantially cuboidal in dimensions, however. In some embodiments, it is dimensioned to accommodate fodder bales of any one of a known set of dimensions, including conventional bales of approximately 30-50 cm×40-60 cm×80-120 cm. In these embodiments, clearly the floor is substantially rectangular with four abutting sidewalls substantially perpendicular to the floor. The interior volume of the container is preferably from 0.25-5 m³.

In other embodiments, the container is adapted to receive loose animal fodder (e.g. hay), or fodder that is contained in nets. In these embodiments, the exact dimensions of the container are not critical, since the user can load the desired amount of fodder into the container for immediate use after treatment.

The container is closable, and is generally opened to allow for loading/unloading of animal fodder, and closed whilst treatment is in progress. The lid therefore mates with the upper edge of wall or walls and forms a seal to enclose the volume within. The lid, or walls, or both, may be provided with a seal to prevent egress of steam.

The container may be made of any suitable material, such as an engineering plastics material. It is preferred that the container is insulated so as to be more energy efficient. This is suitably achieved through use of a double-wall arrangement, which will be known to a person skilled in the art. Preferably, the container and lid are made from double-wall molded plastic material, preferably polypropylene. The container and lid may preferably be rotationally molded, although blow-molding, thermoforming or injection molding may be used.

The lid is preferably made of similar construction to the container. It may be a separate component, i.e. can be lifted off entirely, or may be attached to the container by means of a hinge. The lid may include a catch or hasp to secure it in a closed position, and optionally a gas hinge to facilitate opening and closing.

Animal fodder which may be treated in the apparatus and by the process of the invention includes any agricultural foodstuff used specifically to feed domesticated livestock, such as cattle, rabbits, sheep, horses, chickens and pigs, preferably horses. “Fodder” refers particularly to food given to the animals (including plants cut and carried to them), rather than that which they forage for themselves (called forage). Fodder includes hay, straw, silage, compressed and pelleted feeds, oils and mixed rations, and sprouted grains and legumes (such as bean sprouts, fresh malt, or spent malt). Hay is preferred.

The apparatus of the invention includes at least two steam distributors. “Steam distributer” as used herein refers to a component which receives steam from a source (e.g. a boiler), and projects it into the interior volume of the container in a more even and regulated manner.

The first and second steam distributors are arranged such that when the interior volume of the apparatus is loaded with animal fodder, the mass of animal fodder is located between the steam distributors, such that steam permeates into the mass of animal fodder from substantially opposite directions. This achieves more even and rapid steam treatment compared to devices known in the prior art.

The steam distributors comprise a plurality of steam outlets. As used herein, the term “steam outlet” refers to any element that permits the egress of steam. In a preferred embodiment, the steam outlets may comprise a plurality of apertures in the steam distributor. The apertures may be holes of any appropriate shape, for example round holes having a diameter of between 1 mm and 3 mm; alternatively, they may be in the form of slits. The steam outlets may alternatively comprise a number of projections or hollow points.

In one embodiment, one or both of the steam distributors may comprise a container (such as a shallow box) having an interior volume adapted to receive steam, and provided with a plurality of apertures on one face.

Alternatively, and preferably, one or both of the steam distributors comprise one or more lengths of pipe or tube. In such embodiments, the walls of the pipe are provided with a plurality of apertures allowing for the egress of steam. The apertures in the walls may preferably be evenly spaced, with the spacing sufficient to allow for even distribution of the steam to the mass of animal fodder.

In one arrangement, the pipe may be in the form of an endless loop or ring, provided with a T-joint or side-arm for the admission of steam from the steam source. The pipe can be formed into any appropriate shape, such as a coiled arrangement or a series of parallel loops to present a larger surface area to the mass of animal fodder and hence more even distribution of steam.

Alternatively, one or both of the steam distributors may comprise one or more manifolds which distribute steam to two or more pipes per manifold. The manifold or manifolds are adapted to receive steam from the steam source and convey it to the pipes emerging therefrom. In this arrangement, preferably the pipes comprise an open end in fluid communication with the manifold, and a capped end; these pipes may alternatively be referred to as “spigots”. Again, each pipe comprises a plurality of apertures allowing for the egress of steam. The pipes are usually straight, and radiate from the manifold at equal angles (e.g. 120 ° in the case of three pipes, 90 ° in the case of four), although other arrangements may be contemplated.

In certain embodiments, three pipes are provided per manifold. In alternative embodiments, four or more (such as five or six) may be provided.

In some embodiments, the steam outlets of the first steam distributor may be oriented towards the centre of the interior volume of the container, i.e. inwardly. The steam outlets may be oriented substantially in the same direction, or alternatively be in a range of orientations so as to optimize steam coverage of the mass of animal fodder.

In some alternative embodiments, the steam outlets of the first steam distributor may be oriented away from the centre of the interior volume of the container, i.e. outwardly. In this embodiment, steam emerges towards an inner surface of the container (i.e. a wall, floor or lid), and diffuses back into the mass of animal fodder. In a manner that is not properly understood, this orientation of steam outlets allows for a more rapid treatment of animal fodder using significantly less steam than alternative arrangements. Preferably, the steam outlets are directed so as to direct steam at an angle slightly away from perpendicular to the inner surface of the container, e.g. 10-90 ° away from perpendicular.

The invention employs at least two steam distributors arranged as described above to enclose the mass of animal fodder substantially therebetween. In some embodiments, the apparatus may comprise more than two steam distributors, such as three, four, five or six, depending on the configuration of the interior of the container. These are oriented to provide steam projection from different angles, and permeate the mass of animal fodder more completely.

The first and second steam distributors may be positioned at the walls of the container, on opposing sides. Alternatively, and preferably, the first steam distributor is affixed to the floor of the container, and the second steam distributor is affixed to the lid. In this arrangement, preferably the first steam distributor is in form of an endless loop or ring, and the second steam distributor is in the a plurality of manifolds, each having a plurality of steam pipes projecting therefrom.

In this embodiment, the mass of animal fodder rests on the second steam distributor, being a plurality of manifolds each having a plurality of steam pipes projecting therefrom. Preferably, the pipes are arranged such that they are not in direct contact with the floor of the container, but rather are supported a distance (such as 1-5 cm) above it. As such, the arrangement of pipes and manifolds requires sufficient strength to support the weight of the mass of mass of animal fodder. The steam outlets may be oriented upwards, but as explained above, are preferably directed towards the floor of the container at an angle. An advantage of this configuration, compared to the devices of the prior art, is that the mass of animal fodder is not impaled on spikes or lances, thus allowing for easier unloading.

Also referring to this embodiment, the first steam distributor is in the form of an endless ring or loop. This is arranged around the periphery of the inner surface lid, such that it in use it can distribute steam to the outer portion of the mass of animal fodder.

It has been found that the arrangement described in the foregoing paragraphs is particularly advantageous as it permits even and rapid steaming of the mass of animal fodder, with the first steam distributor and second steam distributor having complimentary steam emission patterns.

It will be understood by the skilled person that the first and second steam distributors may be affixed by any suitable mechanical means, such as screws, brackets or with adhesive.

Steam is supplied to the first and second steam distributors by way of a pipe or tubing that necessarily leads outside of the container. Steam may be generated by any means known in the art, for example a boiler. It is not necessary to describe the functioning of this aspect in further detail.

The apparatus may comprise a steam generator configured to deliver steam to the first and second steam distributors, such that the steam generator forms the steam source. For example, a steam generator may be provided inside the container, or integrated with the container body or housing. In preferred embodiments, the steam generator may be housed in the base of the container, or in a wall of the container.

In an embodiment, the outlet of the steam generator may form the inlet of the steam distributors. By providing the steam generator and the steam distributors in the same housing, the distance that steam must travel between the steam generator and the steam distributors may be reduced or minimised. This may advantageously allow steam to be delivered to the steam distributors at a higher pressure and/or temperature than is possible with a “remote” steam generator, as the steam does not have time to cool down, lose pressure and condense as it travels through piping from the steam generator. Water may be supplied in a separate removable tank.

In a preferred embodiment, however, steam is supplied from a separate steam generator. This is advantageous in that problems associated with low temperature (e.g. water in the device freezing) are circumvented.

In some embodiments, the steam generator comprises one or more than one (such as two, three or four) steam outlets. They may be independently controllable so as to deliver steam at different rates and/or pressure. In the arrangement wherein the steam generator comprises two steam outlets, the first steam outlet is arranged to supply the first steam distributor, and the second steam outlet is arranged to supply the second steam distributor, so that both steam distributors may be independently controlled, e.g. by the computer processor.

Supplied steam may be provided at any suitable pressure, for example greater than atmospheric pressure, preferably at least 1.2 bar, or at least 1.4 bar, or at least 1.6 bar, or at least 2 bar. The pressure and flow rate of the steam may be the same to the first and second steam distributors, or alternatively this may be controlled to provide more pressure and/or volume to the first or second steam distributors. As described hereinafter, this may be achieved under the control of a computer processor, or may simply be achieved by means of e.g. valves or restrictors. The use of pressurized steam may be advantageous, in that it allows fodder to reach the target temperature more quickly and has a greater sterilizing effect.

Steam may be supplied as a continuous flow, i.e. at a steady rate. Alternatively, the flow of steam may be varied over time to achieve a ramped, stepped or pulsed delivery of steam to the fodder. This may be advantageous in achieving a more rapid and complete treatment of the contents.

The container may be sealable in a gas-tight configuration, so that steam pressure inside the container can be increased above atmospheric pressure. However, it is preferred that the container is vented to the atmosphere to avoid a build-up of pressure inside. Usually, this is not a problem, as substantial build-up of pressure does not occur; the steam condenses on the fibres within the mass of animal fodder. It has been found sufficient to provide a drain towards the bottom portion of the apparatus, which allows excess water to run off. A pressure relief valve may also be provided, suitably in the lid of the apparatus. This can be of any type known per se in the art.

The apparatus may be provided with one or more sensors to monitor the steam treatment of the mass of animal fodder. Sensors include the group consisting of temperature sensors, pressure sensors and/or humidity sensors. The temperature sensor may preferably be provided on a probe insertable into the mass of animal fodder during steaming. Data collected by the sensor or sensors may be relayed to the computer processor.

The computer processor is adapted to receive data from the sensor or sensors described above, process these data, and control the provision of steam to the first and second steam distributors. The computer processor may have a data connection to a data storage device, which contains data relating to parameters such as target temperature and moisture level. Thus, in one embodiment, the process is substantially controlled by the computer processor. The computer processor may be programmable by the user to select the process parameters, such as time, temperature and humidity.

The computer processor may be located on the exterior of the container, or in a preferred arrangement, on the steam generator. The computer processor may additionally have data storage, a display, an input (e.g. buttons or a keyboard), and connectivity (preferably selected from Wi-Fi, ethernet, LoRa or mobile data such as 4G or 5G) to enable a data connection to a remote computer or mobile device.

In one embodiment, the apparatus is adapted to deliver a predetermined volume of steam to the mass of animal fodder. This will depend on e.g. the initial degree of moisture of the animal fodder, the target moisture level, and the target temperature to be achieved. This is preferably achieved under the control of the computer processor.

The method may operate in a steam sterilisation mode for killing bacteria on plant fibres (i.e. animal fodder), in which the apparatus delivers steam to raise the temperature of a mass of animal fodder to a target temperature range of between 90 °C and 104 °C. The apparatus may preferably be configured to deliver steam to raise the temperature of the mass of animal fodder to a temperature of at least 90 °C for a period of at least 10 minutes, or at least 15 minutes, or at least 20 minutes. Lower temperatures and steaming durations may be insufficient to ensure harmful microorganisms have been killed by steaming.

The description hereinbefore refers to treatment of a mass of animal fodder with the apparatus, which as explained, comprises plant fibres. Alternatively, the plant fibres may be industrial fibres such as industrial hemp or tobacco.

In some embodiments, the invention provides a device with a plurality of outlets adapted to distribute steam via diffusors to a bale of plant fibres; temperature sensors for sensing the temperature of the plant fibres; a plurality of pressure sensors to sense the pressure of the steam supplied to the bale; and a computer processor configured to communicate with the temperature sensors and/or the pressure sensors and hence control the temperature or pressure or both, of the steam released based on the signal received therefrom.

The device and method of the present invention aims to achieve the steam/moisture and/or temperature control from any or all the orientations of the plant fibre within the device. Specifically, the device and method of the present invention distributes steam from the outside to the inside of the mass of animal fodder (also referred to as “batch”) within the device, as opposed to the prior art which is focused on delivering steam from the interior of the plant fibre bale to the exterior. The device may operate either based on immediate feedback from the sensors in the chest or based on a pre-programmed schedule that varies according to measured parameters, for example, how full the chest is, the outside temperature, the degree of moisture of the fodder, etc.

In some embodiments, the steam outlets of the device are located at different positions within the device which distribute steam to the bale of plant fibres via diffusors. The steam outlets are placed above, below and/or on the sides of the bale in the chest, creating a surrounding atmosphere of steam. The functioning of the steam outlets can be controlled by the computer processor. For example, steam outlets on any given side can be controlled independently of the steam outlets on the other sides. In some embodiments, the computer processor is programmable by the user. Thus, when a computer processor is programmed with a pre-set parametric value (e.g. temperature), the steam is supplied until that value is reached. In other embodiments, the sensors communicate with the computer processor which then controls (e.g., releases or stops) the supply of further steam. The computer processor in such a way is configurable for the steam outlets on any side. The parameters preferably include temperature, moisture or both. This results in rapid and even steaming of the plant fibres within the mass of animal fodder, and hence shortens the treatment time. This advantageously results in more complete steaming of the plant fibres throughout the mass, as compared to the devices of the prior art which are focused on steaming only from one direction. In another embodiment of the invention, the steam is replaceable with a liquid such as water or any solution of flavouring agent or any solution containing a supplement or additive.

In one embodiment, the steam outlets are defined by a hole or series of holes in a pipe into which steam is fed. The pipe may have a closed end. Alternatively, the pipe may form a loop with an inlet for the delivery of steam, with holes spaced along the circumference of the pipe.

In one embodiment, the device is provided with a manifold which distributes steam to a plurality of pipes comprising holes as described above.

In certain embodiments, pressure sensors controllable by the computer processor are provided on the sides on the device. The pressure sensors may be provided in the form of valves. The valves allow controlled release of steam into or out of the device based on a predetermined value. The level of steam is thereby maintained based on such configuration. Pressure sensors communicates pressure signals to the computer processor. The release of steam is mediated through vents which are openable and closable.

In one embodiment, the moisture of the batch of plant fibres may be controlled based on the predetermined value. In another embodiment, the computer processor receives a signal from various moisture check points installed in the devices. Based on the signal received the computer processor either stops the supply or release the liquid from the liquid source to the device.

In one embodiment, the temperature sensors and a temperature probe are installed within the device to monitor and/or measure the temperature around and inside of the batch of plant fibres during steaming and after steaming, and to communicate temperature signals to a computer processor. For example, based on regular communication between the sensors and the computer processor, the temperature of the plant fibres may be maintained at a target value for a target period of time.

In one embodiment, depending on the quantity of fodder and the ambient temperature, a pre-set procedure of introducing steam may be used. This means that steam is delivered to different points inside and around the batch, providing more uniform steaming throughout than would be possible with steam introduced just from the bottom of the device with a single or double manifold without any control.

The steam in any given embodiment is replaceable with a liquid or gas or may be combined with a liquid or gas. In another embodiment, supplements and/or flavoring agent(s) may be added to the liquid. These may impart nutritional benefits and/or palatability to the fodder. The liquid reservoir may be configured to pass liquid, without being converted to steam, to the batch of plant fibre via a diffusor. The liquid may be passed at a particular temperature and/or pressure which is controllable by the computer processor. This causes rapid increase in the moisture level of the plant fibres in the mass of animal fodder. This is useful in cases where high moisture content of the plant fibres is required. For example, the liquid can be water. The moisture content of the plant fibres in the animal fodder may be between 15% to 30%, preferably between 18% to 22%, after treatment.

In a preferred embodiment the diffusors, pressure sensors and temperature sensors are provided inside the device, which is preferably insulated and air-tight so that steam may be built up within the container.

In another embodiment there is provided a method of treating a mass of animal fodder with steam or liquid. For example, in a method of steam treating plant fibres, a mass of animal fodder is placed in a container in the device. Depending on the quantity and quality of the plant fibre in the mass of animal fodder, the computer processor is programmed with the target parametric values. Steam is supplied to the diffusors into the mass of animal fodder placed inside the device according to the pre-set values. Monitoring the computer processor for any data received from the device and based on any signal received from the temperature and pressure sensors, enables identification of the areas of a mass of animal fodder which requires more or no steam. Then, the manifolds controlled by the computer processor release steam so as to lower or raise the temperature at any given point.

The apparatus of the present invention is particularly suitable for steam treating batches of plant fibres which are typically loose or in a net, which is intended to include bales as well as retaining nets, bags, baskets or similar receptacles.

### Description of Specific Embodiments With Reference to the Figures

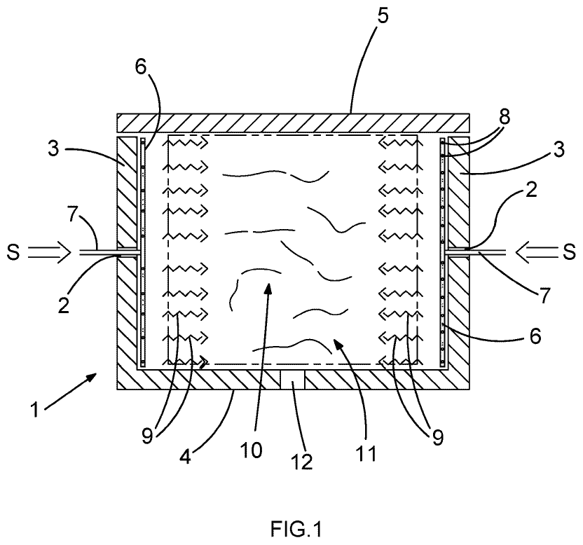

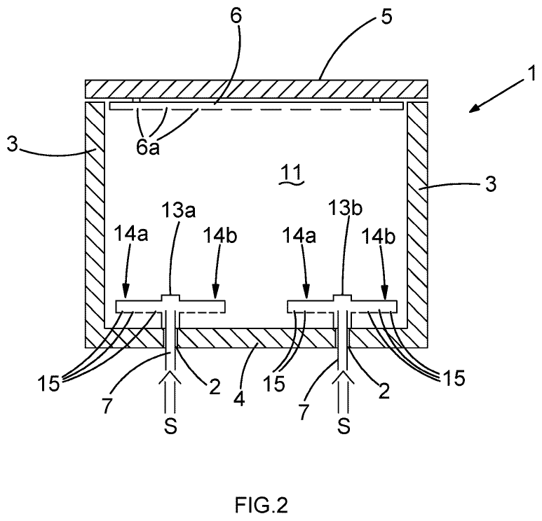

FIG. 1 is a sectional view of a device according to one embodiment of the invention. The device comprises an insulated container (FIG. 1-1) having left and right sidewalls (FIG. 1-3) abutting and substantially perpendicular to floor (FIG. 1-4). A lid (FIG. 1-5) abuts the top edge of left and right sidewalls (FIG. 1-3) and closes the container. Left and right sidewalls are provided with apertures (FIG. 1-2) through which project steam delivery hoses (FIG. 1-7). Steam delivery hoses are connected at one end to a steam supply (“S”), and at a second end to left (first) and right (second) steam distributors (FIG. 1-6) in the form of pipes having apertures (FIG. 1-8) spaced at regular intervals along their walls. Steam (FIG. 1-9) emerges from apertures (FIG. 1-8) and enters interior volume (FIG. 1-11). As can be seen, the direction of flow of the steam from the left and right steam distributors is substantially opposite. A mass of loose animal fodder (FIG. 1-10) is present in interior volume (FIG. 1-11). Steam permeates into the animal fodder and is thereby steam treated. A drain hole (FIG. 1-12) is provided in the floor (FIG. 1-4).

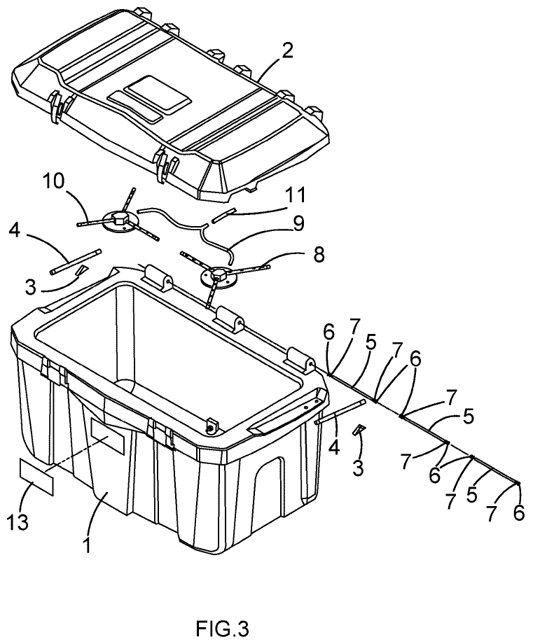

A second embodiment of the invention is shown in FIG. 2. Again, the device comprises an insulated container (FIG. 2-1) having left and right sidewalls (FIG. 2-3) abutting and substantially perpendicular to floor (FIG. 2-4). A lid (FIG. 2-5) abuts the top edge of left and right sidewalls (FIG. 2-3) and closes the container. Left and right sidewalls (FIG. 2-3) together with front and back sidewalls (not shown), floor (FIG. 2-4) and lid define an interior volume (FIG. 2-11). The floor (FIG. 2-4) is provided with apertures through which project through which project steam delivery hoses (FIG. 2-7), and deliver steam (“S”) to left (FIG. 2-13a) and right (FIG. 2-13b) manifolds. Steam from the left (FIG. 2-13a) manifold is supplied to closed-end pipes (FIG. 2-14a) and (FIG. 2-14b) which are provided with a plurality of apertures (steam outlets, FIG. 2-15). Steam from the right (FIG. 2-13b) manifold is supplied to closed-end pipes (FIG. 2-14a) and (FIG. 2-14b) which are provided with a plurality of apertures (steam outlets, FIG. 2-15). Manifolds (FIG. 2-13a), (FIG. 2-13b) and pipes (FIG. 2-14a), (FIG. 2-14b) together form the first steam distributor. The closed-end pipes (FIG. 2-14a) and (FIG. 2-14b) sit somewhat above floor (FIG. 2-4); steam outlets (FIG. 2-15) are directed so as to emit steam toward the floor (FIG. 2-4) at an angle off perpendicular. Affixed to lid (FIG. 2-5) is a second steam distributor, which in the embodiment shown is an elongate tube (FIG. 2-6) closed at both ends. Along its length, an elongate tube (FIG. 2-6) is provided with a plurality of apertures (FIG. 2-6a); it is affixed to lid (FIG. 2-5) by means of brackets. The plurality of apertures (FIG. 2-6a) is oriented so as to emit steam toward the interior volume (FIG. 2-11) and away from lid (FIG. 2-5). Steam is supplied to the elongate tube (FIG. 2-6) by means of a T-connector (not shown) approximately at the midpoint, which further connects to a steam supply.

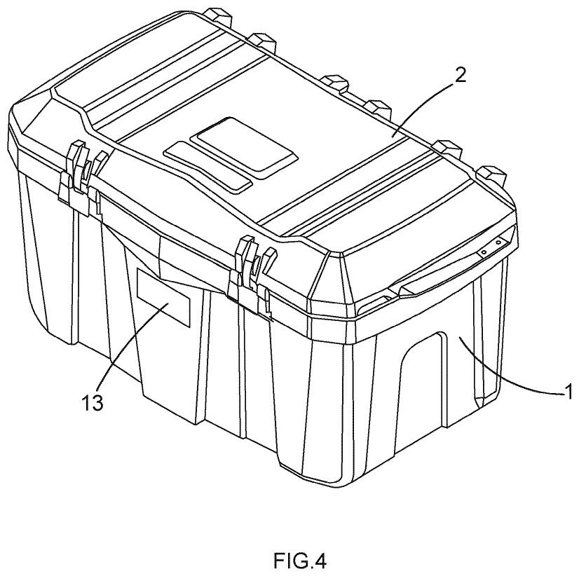

FIG. 3 is an exploded view of a device according to one embodiment of the invention. Container (FIG. 3-1) is in the form of a substantially cuboidal chest having walls, a base, an open top and a floor, together defining a cavity dimensioned so as to accommodate a mass of animal fodder. The rear wall features hinge knuckles along its upper edge. Lid (FIG. 3-2) is dimensioned so as to fit and seal the container (FIG. 3-1), and features hinge knuckles. Pins (FIG. 3-5) are dimensioned so as to pass through the knuckles on the lid and rear wall and so pivotally connect them, enabling the lid to open and close. The pins are secured with washers (FIG. 3-7) and nuts (FIG. 3-6). Opening and closing is facilitated by means of gas springs (FIG. 3-4).

The floor of the chest is provided with two steam distributors (steam plate assemblies) (FIG. 3-8), connected to a bifurcated flexible steam hose (FIG. 3-9). Bifurcated flexible steam hose is connected at the bifurcation to a tubular connector (FIG. 3-11), which passes through a hole at the base of the rear wall, and in use is connected to a supply of steam (not shown).

FIG. 4 shows the assembled device of FIG. 3 with the lid (FIG. 3-2) closing the container (FIG. 3-1). It is secured at one edge with catches.

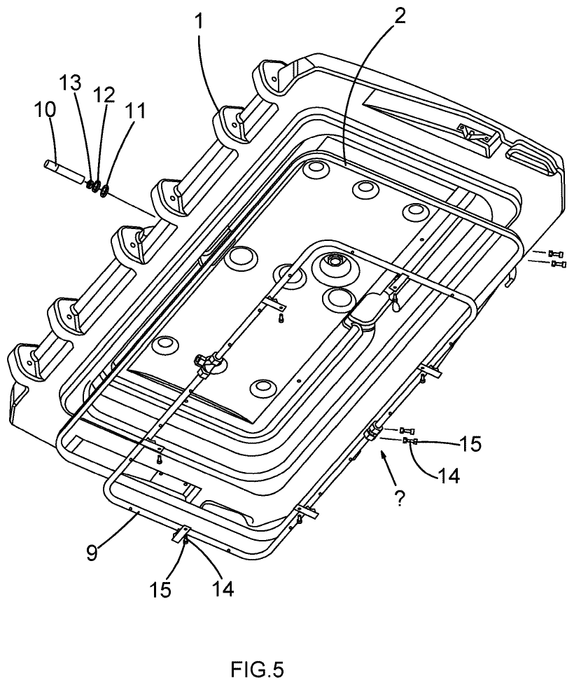

FIG. 5 is an exploded view of the interior of the lid showing the lid steaming assembly. The interior of the lid moulding (FIG. 5-1) features a rectangular recess adapted to receive the lid steaming rail (FIG. 5-9). This takes the form of an endless rectangular tube having radiused corners, provided with a T-joint for the introduction of steam substantially at the midpoint of one long side. The lid steaming rail (FIG. 5-9) is provided with a plurality of holes permitting the egress of steam. The lid steaming rail (FIG. 5-9) is secured to the lid moulding (FIG. 5-1) by means of six mounting brackets adapted to receive screws (FIG. 5-14) which are secured into holes in the roof of the rectangular recess.

A connector pipe (FIG. 5-10) passes through a hole provided in the rectangular recess, and connects at the inner end to the T-joint. The other end of the connector pipe sits outside the lid, and in use is connected to a supply of steam (not shown). A flexible seal (FIG. 5-2) is provided around the periphery of the recess, and in use forms a seal with the upper edge of the container walls.

The lid steaming rail (FIG. 5-9) sits a slight distance within the periphery of the rectangular recess. The plurality of holes in lid steaming rail (FIG. 5-9) are directed downward, and when in situ point towards the interior of the container.

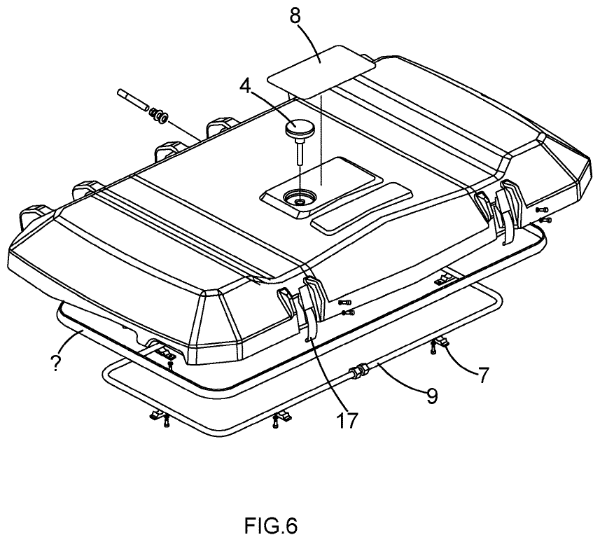

FIG. 6 shows the exterior of the lid depicted in FIG. 5, which is provided a pressure relief valve (FIG. 6-6).

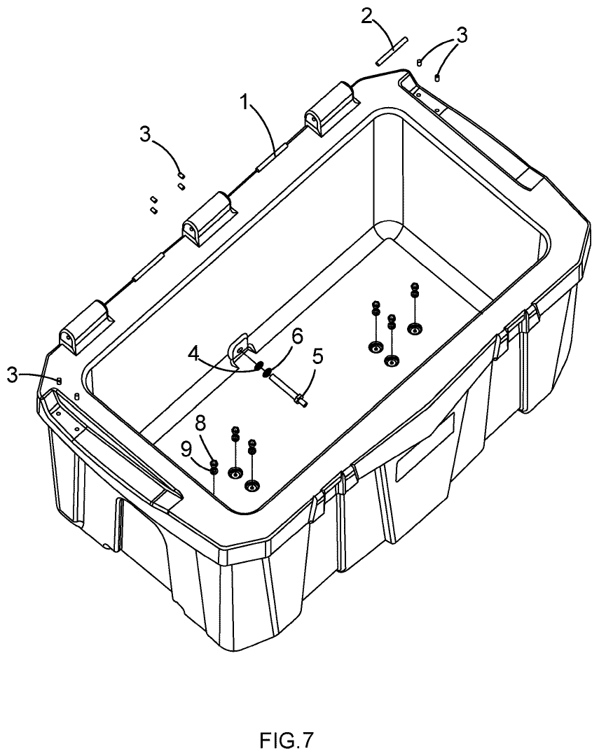

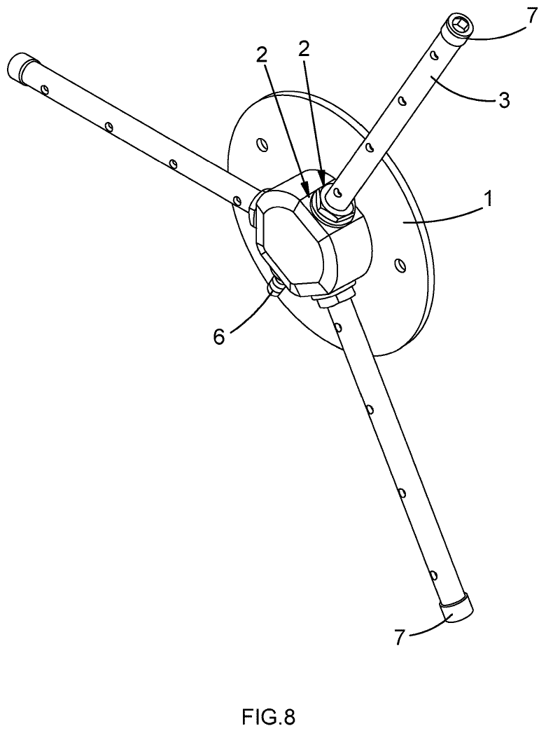

FIG. 7 shows the container moulding and the cavity. The floor of the container is provided with fixings (FIG. 7-8), (FIG. 7-9) for securing steam plate assemblies/steam distributors.

Detail of a steam plate assembly (steam distributor) is shown in FIG. 8. A manifold (FIG. 8-2) is connected to baseplate (FIG. 8-1). Three steam tubes (FIG. 8-3), each including a number of steam outlet holes, terminate at a first end at the manifold (FIG. 8-2), and are capped at a second end.

### EXAMPLES

10 samples of plant fibres are treated using various settings of the device.
Samples of animal fodder are placed in the device depicted in FIG. 3 and subjected to steam treatment. Steam is provided to the device for 10 minutes. The respirable dust particles, bacterial contamination and fungal spore load is reduced by at least 99%

1. An apparatus for steam treating animal fodder comprising:
i. a closable container having a floor, wall or walls abutting the floor, and a lid, together defining an interior volume for receiving a mass of animal fodder;
ii. a first steam distributor within the container adapted to receive steam from a source, comprising a first plurality of steam outlets; and
iii. a second steam distributor within the container adapted to receive steam from a source, comprising a second plurality of steam outlets;
wherein, in use, the mass of animal fodder is located substantially between the first and second steam distributors such that steam permeates into the mass of animal fodder from substantially opposite directions.

2. An apparatus according to claim 1, wherein the first steam distributor comprises one or more pipes, and the steam outlets comprise a plurality of apertures provided along the length of the pipe or pipes.

3. An apparatus according to claim 1, wherein the second steam distributor comprises one or more pipes, and the steam outlets comprise a plurality of apertures provided along the length of the pipe or pipes.

4. An apparatus according to claim 2, wherein the pipe or pipes are in the form of a ring.

5. An apparatus according to claim 2, wherein the pipe or pipes project from one or more manifolds.

6. An apparatus according to claim 5, wherein three or four pipes project from each manifold.

7. An apparatus according to claim 5, further comprising two or three manifolds.

8. An apparatus according to claim 1, wherein the first steam distributor is affixed to the floor of the closable container.

9. An apparatus according to claim 1, wherein the second steam distributor is affixed to the lid of the closable container.

10. An apparatus according to claim 1, wherein at least the first steam distributor, the second steam distributor or both are arranged to project steam substantially towards the interior volume of the closable container.

11. An apparatus according to claim 1, wherein at least the first steam distributor, the second steam distributor or both are arranged to project steam substantially away from the interior volume of the closable container, such that the steam is diffused before permeating into the mass of animal fodder.

12. An apparatus according to claim 1, comprising one or more of temperature sensors, pressure sensors and/or humidity sensors.

13. An apparatus according to claim 1, further comprising a computer processor adapted to control the pressure and/or volume of steam delivered to the first and second steam distributors.

14. An apparatus according to claim 13, wherein the computer processor is configured to receive a signal from at least one temperature sensor, and to control the supply of steam to the first and second steam distributors to raise the temperature of the mass of animal fodder to a target level.

15. An apparatus according to claim 13, wherein the computer processor is adapted to deliver a predetermined amount of steam.

16. An apparatus according to claim 1, further comprising a steam generator.

17. A method of steaming a mass of animal fodder comprising:
i. placing the mass of animal fodder between a first and second steam distributor;
ii. delivering steam from a steam source through the first and second steam distributors; and
iii. stopping the supply of steam when a predetermined volume of steam has been delivered.

18. A method according to claim 17, wherein the fodder is provided as a bale, loose plant fibres, or as a batch in a mesh bag or container.

19. A method according to claim 17 in which the steam supply is controlled so that the temperature of the batch of plant fibres is maintained at a target level for a predetermined period of time.
